(19) United States
(12) Patent Application Publication
(10) Pub. No.: US 2015/0320638 A1
(43) Pub. Date: Nov. 12, 2015

(54) MILK BOTTLE ADAPTER

(71) Applicant: FRESENIUS KABI DEUTSCHLAND GMBH, Bad Homburg (DE)

(72) Inventors: Michael Becker, Knittlingen (DE); Barbara Amon, Idstein (DE); Sabine Althaus-Krohn, Friedrichsdorf (DE)

(21) Appl. No.: 14/652,848

(22) PCT Filed: Dec. 3, 2013
(86) PCT No.: PCT/EP2013/075390

§ 371 Date: Jun. 17, 2015

Related U.S. Application Data
(60) Provisional application No. 61/740,499, filed on Dec. 21, 2012.

(30) Foreign Application Priority Data
Dec. 21, 2012 (EP) 12199006.3

(51) Int. Cl. A61J 1/14

(52) U.S. Cl. CPC A61J 1/1412; A61J 1/1443

(57) ABSTRACT

A cap for a milk container, in particular for a milk bottle, comprising a holder for securing the cap on the milk container, and a female connector element, which is arranged as a through-opening in the cap, for connection to a male connector element, wherein at least the female connector element has an antimicrobial surface at least in part.

The invention relates to a cap for a milk container, in particular for a milk bottle, comprising a holder for fastening the cap on the milk container or fixed to the milk container. The invention also relates to a milk bottle and to a set comprising such a cap.

Caps according to the invention are used for connecting a tube, such as a tip of a syringe, to produce a conduit via which a medium can be transferred through the tube and the cap.

In neonatology and pediatrics, when the state of development of the gastrointestinal tract of a premature baby allows it, or when infants have problems sucking, liquid food is administered via feeding tubes. If possible, that is to say if the mother is capable of using for example a breast pump to pump breast milk into a milk container, in particular into a milk bottle, the liquid food administered is preferably breast milk.

A milk container within the context of the present invention is a storage container with rigid or flexible walls which is suitable for storing breast milk so that the latter is then suitable, and can be used, for feeding infants such as babies and premature babies. The milk container thus has to consist of suitable materials in order to hold the liquid (the breast milk) and not to contaminate the liquid by harmful substances or microorganisms and therefore render the liquid unusable. Such a milk container comprises, for this purpose, an opening, via which the breast milk can be introduced. It is also possible for the breast milk to be removed via said opening or some other opening. The milk containers usually have a wide neck, which may be connected, for example, to a teat, the end of the pumping device and/or a top. Typical milk containers are therefore, for example, commercially available milk bottles, e.g. baby bottles, with a wideneck thread. It is also possible, however, to use bags as milk containers. The breast milk from the breast of the mother of the premature baby is pumped into a milk container and possibly treated.

For the enteral feeding of premature babies, the breast milk is prepared in the premature-baby unit or the milk kitchen of the hospital and removed from the milk container by means of a syringe. Depending on the physical development of the premature baby, the breast milk removed is administered, for example, by a nasogastric feeding tube. Since the patients' stomachs are very small (approximately 3 cm in diameter), the feeding has to be done in very small portions (on average approximately 7.5 ml per syringe). It is therefore necessary to prepare up to twelve syringes with food for each premature baby per day.

The breast milk, currently, is removed from the milk container by the tip of a syringe being immersed in the liquid and the liquid then being withdrawn by the syringe.

The disadvantage here is that this procedure is complicated and involves difficult handling. In addition, there is a risk of some of the breast milk being lost as it is withdrawn. Furthermore, the situation where an unused residual quantity of milk remains in the milk container cannot be ruled out.

Also, the breast milk may be contaminated via the opening of the milk container. Furthermore, the entire procedure takes a lot of time and is laborious, which is particularly disadvantageous in often busy hospitals.

It is an object of the invention to overcome these disadvantages and others which have not been mentioned. Breast milk is the best possible food for the development of premature babies. It is therefore very important and in particular an object of the present invention, to provide an apparatus in the case of which the breast milk, as far as possible, is not contaminated and the loss of breast milk is avoided as far as possible. In addition, the intention is for all the breast milk, as far as possible, to be usable. Straightforward use and reliable administration by the hospital staff likewise constitute an object of the present invention. At the same time, the apparatus should be of straight forward and cost-effective construction.

These objects are achieved by a cap for a container for accommodating a liquid, in particular for enteral nutrition, preferably for a milk container, for example for a milk bottle, comprising a holder for fastening the cap on the container, in particular a milk container, and also comprising a female connector element which is arranged in the form of a through-opening in the cap and is intended for connecting to a male connector element, wherein at least the female connector element, at least in part, has an antimicrobial surface. The female connector element comprises a tube which, at least on part of the inside of the tube, has the antimicrobial surface. The liquid is, in particular, a liquid for enteral nutrition, for example milk.

In the case of a such a cap according to the invention, the male connector element may be a tip of a syringe. The tip of a syringe, or some other connecting element, can be accommodated, in the case of caps according to the invention, in the female connector element, in order to form a reliable and germ-free connection between a connected milk container and the syringe. This preferably provides a fluid-tight connection which allows a liquid to be directed through the cap.

The cap can be connected in a releasable manner to the syringe. An antimicrobial surface, within the framework of the present invention, is understood to mean a surface which contains, or consists of, an antimicrobial substance, which reduces in particular the capacity of microorganisms to multiply, or the effectiveness thereof, or kills off microorganisms or renders them inactive.

Provision may be made here for the holder to be a wideneck-bottle adapter, a narrowneck-bottle adapter and/or a plug-in connection, wherein the holder comprises preferably a plurality of possible connection means.

In the case of caps with wideneck-bottle adapters according to the invention, provision may be made for the wideneck-bottle adapter to have a diameter of 2 cm to 10 cm, preferably a diameter of 3 cm to 8 cm, particularly preferably a diameter of 4 cm to 6 cm.

If wideneck-bottle adapters are used as the holder, it is also possible for commercially available milk bottles, in particular baby bottles, to be used as milk containers. This has the advantage there is no need for separate storage. Variable multipurpose connections allow use with different milk containers.

According to a further configuration of the invention, provision may be made for the cap to be connectable in a fluid-tight and/or releasable manner to the male connector element, wherein preferably the inner lateral surface of the depression can be connected all the way round and/or over the surface area with an at least partially matching male connector element. Provision can particularly preferably be made here for the inner lateral surface of the depression to be connectable in a form-fitting manner to an at least partially matching tip of the syringe. Provision may also be made for the inner lateral surface of the depression to be connected all the way around and over the surface area, preferably in a form-fitting manner, to an at least partially matching tip of the syringe.

The sealing of the connection results in a lower risk of breast milk being lost and in a lower risk of the breast milk being contaminated. A releasable tip of the syringe renders multiple use possible.

Provision may also be made according to the invention for the female connector element, at least in part, to be conical, and for it to be possible for an at least partially conical male connector element to be accommodated in the female connector element. Preferably, the depression in the female connector element is conical and a conical male connector element can be accommodated therein. Provision may also be made according to the invention for the male connector element to be accommodated in the female connector element or the depression or to be fastened, preferably screwed, therein. The conical shape results in better sealing of the connection, since a conical male connector element can be plugged in a force-fitting manner into the depression.

In one configuration, the female connector element and/or the male connector element are/is designed in the form of a female and/or male connector element for enteral and/or gastric application. In a first variant, the female and/or male connector element are/is designed in the form of a male and/or female PG lock connector element. The aforementioned PG lock connecting system is known to a person skilled in the art and has been submitted as a draft to the ISO working group ISO/CD 80369-3 “Enteral and gastric applications” and is available for inspection there. In a second variant, the female connector element and/or the male connector element are/is designed in the form of a female and/or male EN lock connector element. Such an EN lock connecting system is known to a person skilled in the art and described, inter alia, in WO 2010/115598 A1. Furthermore, the EN lock connecting system has been submitted as a draft to the ISO working group—TC210/JWG4, PG 3—enteral connectors—and is available for inspection. The contents of the aforementioned patent application are incorporated in full in the present patent application by way of reference.

In one configuration of the invention, the antimicrobial surface is provided by an antimicrobial coating and/or by an antimicrobial material. The antimicrobial material is embedded for example fully or partially in the material of the female connector element. Provision may be made for the antimicrobial surface to be an antimicrobial coating of the surface of the depression or of the opening. Coatings mean that only the relevant surfaces have to contain an antimicrobial active substance and there is no need for all of the material to contain the same.

In one embodiment, provision is made for the antimicrobial surface to comprise silver, preferably silver particles, in particular with an average diameter of less than 1 μm.

Such antimicrobial surfaces, for example with silver or nanosilver coatings, provide long-term antimicrobial action, which can reduce the use of disinfectants. This reduces the pressure on the patients' immune systems and prevents the patients from suffering allergic reactions.

According to one embodiment of the invention, provision is made for the depression to comprise an internal thread for fastening a male connector element with an external thread. The internal thread and/or the external thread may be provided by a single thread turn.

Caps according to the invention may also be distinguished in that the cap comprises a fluid-tight ventilating channel, preferably comprising a ventilating valve and/or a ventilating filter, in particular a bacteria filter. The ventilating valve and/or the ventilating filter preferably have/has, at least in certain regions, a hydrophobic surface. This measure also makes it possible to use milk bottles which do not have any flexible walls. Pressure equalization takes place via the ventilating channel. The hydrophobic surface allows the cap to be stored on a milk container in a refrigerator without there being any risk, following removal from the refrigerator of the filter becoming unusable, or being adversely affected, by condensing water from the air (air humidity) or of ventilation being interrupted, in which case less breast milk, if any at all, can pass into the syringe.

A further configuration of the invention may provide for the cap, in particular the female connector element, to comprise a fastening device for fastening the male connector element. The fastening device is preferably configured in the form of a rotary locking element, a bayonet closure or a thread. The fastening device can be connected in a releasable manner to the complementary connector element. This makes possible a stable connection between the syringe and the milk container, and therefore said connection does not loosen in an undesired manner and put the patient's health at risk.

According to a further embodiment of the invention, the female connector element extends preferably centrally through the cap and/or beyond a top surface of the cap. It can be covered preferably by a closure. Provision may be made for the opening, with the depression, to be formed in a tube which extends, in particular centrally, through the cap, wherein, preferably at least on the side for introduction of the male connector element, the tube projects beyond a top surface of the cap and can be, or is, covered particularly preferably by a closure.

The tube means that the contact surface between the cylindrical depression and the tip of the syringe can be configured with a particularly large surface area and thus in a stable and sealed manner. There is then no need for the “top part” with the top surface of the cap to be of a particularly thick configuration, that is to say it may be a thin configuration (less than 4 mm thick), in order for the connection between the male connector element and the cap to be sufficiently stable.

Provision may also be made for the cap, in the region of the opening, in particular the female connector element, to have a nonreturn valve, preferably a duckbill valve. This prevents backflow of fluid into the milk container and thus prevents the precious breast milk from being contaminated.

The invention also covers a liquid container for enteral nutrition, in particular a milk bottle, comprising such a cap, in the case of which the cap is connected in a releasable manner to the liquid container, in particular to the milk bottle, or is fixed to the liquid container, in particular to the milk bottle, preferably is configured in one piece with the liquid container, in particular the milk bottle.

The invention further covers a set comprising such a cap, wherein the set comprises a liquid container for enteral nutrition, in particular a milk bottle. Provision may be made here for the set to comprise, in addition, a syringe with a male connector element. Provision may also be made for the set to comprise, in addition, an extension which is designed in the form of a tube or of a hose and has a first end, which can be connected to the female connector element of the cap, and a second end, which has a further female connector element for connecting to a male connector element. The set may comprise a tube or a flexible hose which, at a first end, can be, or is, connected to the opening and, at the other end, comprises a depression for a male connector element, wherein preferably the other end has arranged on it a closure by which the hose or the tube can be, or is, covered. This means that even an ill-positioned syringe can be connected, via the cap, to a milk container which can be reached by the syringe only with difficulty, if at all.

The invention is based on the finding that a straightforward adapter (a cap) with a depression for accommodating a male connector element makes it possible to use commercially available milk bottles for breast milk even for the enteral nutrition of premature babies. This means that, with the aid of the cap according to the invention, the same milk bottles which are used for feeding babies with a teat can also be used for the enteral nutrition of premature babies. The antimicrobial surface, for example a coating, makes it possible to ensure that there is no contamination of the breast milk here.

Milk-bottle caps according to the invention thus provide the safety feature that it is not possible for contamination with bacteria or other germs to occur. A reliable connection between a syringe and the milk container is ensured in addition, and it is therefore not possible for any breast milk to be lost. Connector elements based on the EN lock connecting system (conical depression as female connector element with internal thread and the conical tip of a syringe as male connector element with external thread) prevent the accommodation of tips of syringes for intravenous treatments based on the Luer or Luer lock system (in which the female connector element comprises an external thread and the male connector element is enclosed by a piece of tube with an internal thread), and therefore there is no chance of a mix-up and even the risk of connection in the wrong direction is eliminated. The sealed connection guarantees through-passage of the breast milk without any losses.

The cap may be silver-coated, in order to be effective over a relatively long period of time against bacteria or microorganisms. The cap can be used as a milk-bottle adapter or milk-bottle attachment. It may comprise, according to the invention, a ventilating valve with an integrated bacteria filter. This makes it possible to withdraw liquids from flexible milk containers (such as bags) or non-flexible milk containers (such as syringes, accommodating containers or baby bottles). The ventilating valve allows air to flow in and prevents liquid from escaping.

An integrated duckbill valve can allow unidirectional flow through the cap, wherein forward flow (out of the milk container) is possible and contamination by backflow is prevented.

Since milk containers according to the invention are occasionally stored in refrigerators possibly with the caps, it is possible for at least the filters to be produced from a hydrophobic material, in order to prevent the filter from being blocked or adversely affected by condensation.

In order to prevent the contents of milk containers according to the invention from leaking, when said containers are used with the opening in the downward direction, the invention can provide an automatic closure system on the cap, in particular at the bottom end thereof (directed toward the milk container).

Using an antimicrobial coating in the region of the opening, in particular in the depression (for example a coating with silver or nanosilver) makes it possible to kill off microorganisms such as bacteria and fungi. In addition, this makes it possible to reduce the use of disinfectants. Since disinfectants can lead to allergic reactions in patients, in particular in infants, the use of an antimicrobial coating can avoid the situation where the patients are subjected to additional pressure.

A crown-cap seat and film-cutting saw teeth on the inner side of the cap are not necessary, but are possible. The cap may be produced essentially from a plastics injection molding. There is no need for a number of individual parts to be put together, for example adhesively bonded.

The cap provides a connection between a milk bottle and a syringe with a male connector element and can be used both in the clinical and home-care sectors.

Exemplary embodiments of the invention will be explained hereinbelow with reference to seven schematically illustrated figures, albeit without any limitation to the invention. In the figures:

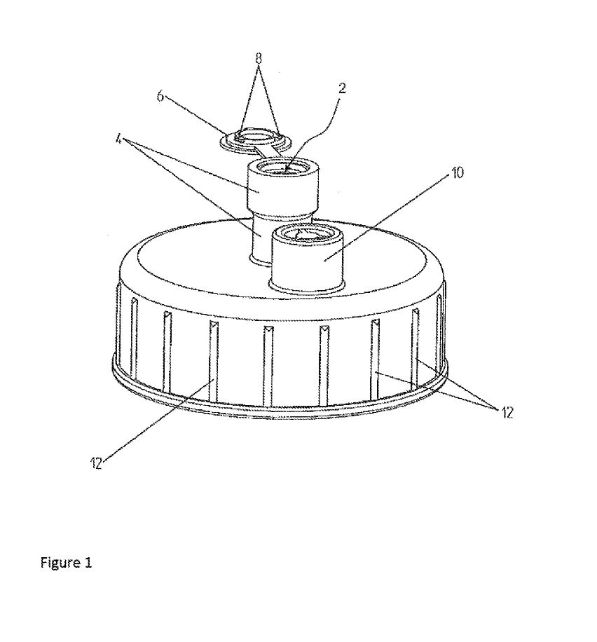

FIG. 1 shows a schematic perspective view of a cap according to the invention;

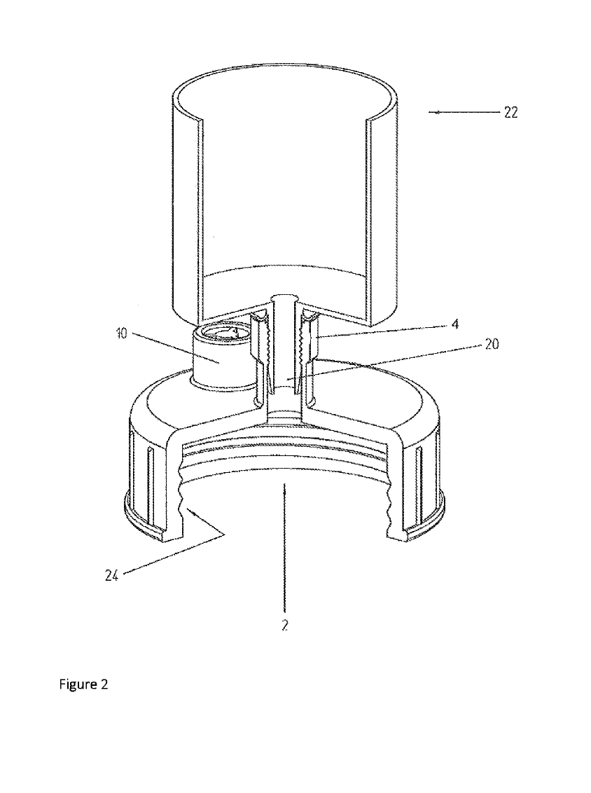

FIG. 2 shows a schematic perspective view, in section, of a cap according to the invention with the tip of a syringe inserted;

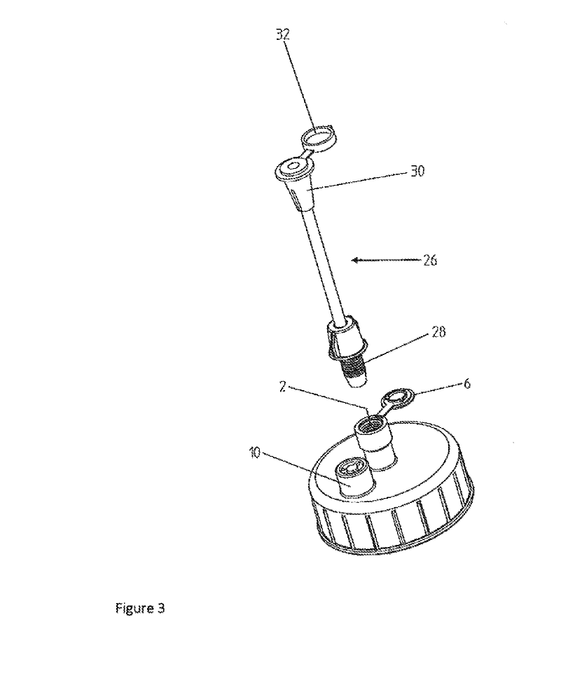

FIG. 3 shows a schematic perspective view of a cap according to the invention with an extension;

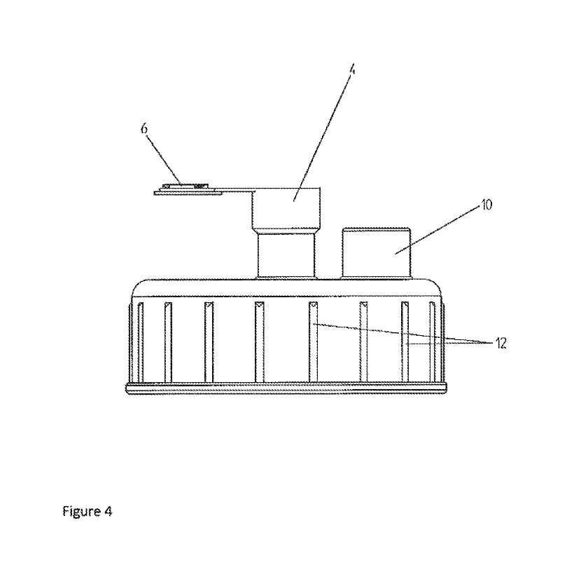

FIG. 4 shows a schematic side view of a cap according to the invention;

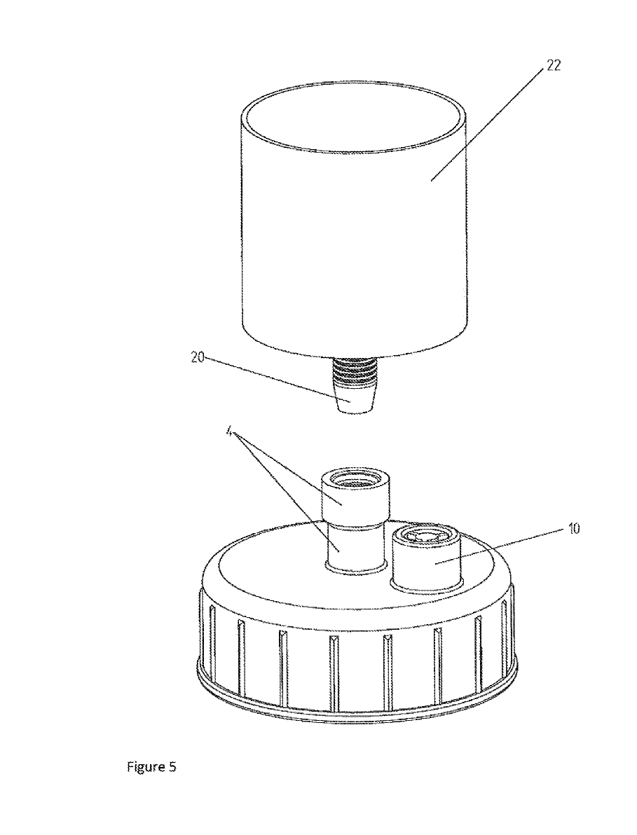

FIG. 5 shows a schematic perspective view of a cap according to the invention with a syringe not yet inserted;

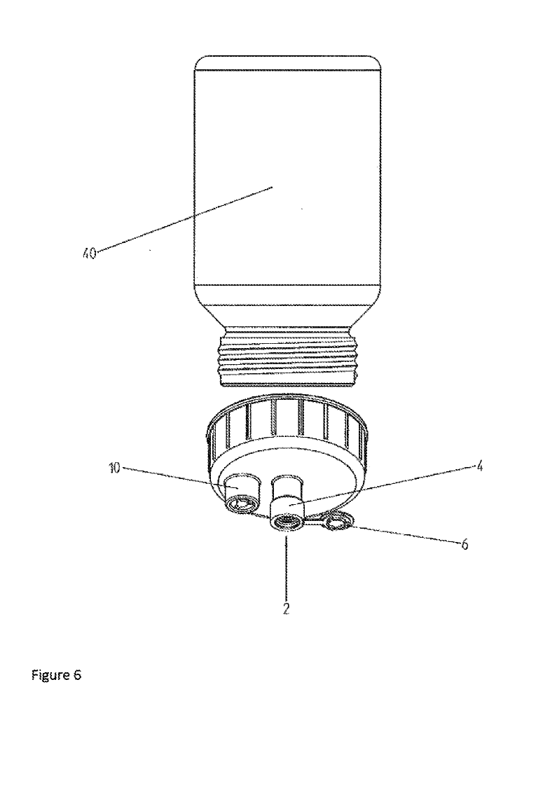

FIG. 6 shows a schematic perspective view of a cap according to the invention with a milk bottle not yet connected; and

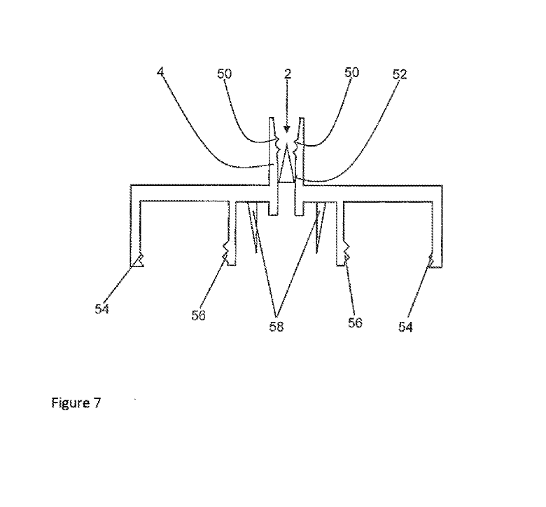

FIG. 7 shows a schematic cross-sectional view of a cap according to the invention with a duckbill valve in the opening.

FIG. 1 shows a schematic perspective view of a cap according to the invention. The cap is constructed in the manner of a screw closure for a milk container (not shown) with a wide neck. It can be screwed, in the form of a screw top, onto such a milk container. For this purpose, the cap comprises an internal thread on the underside (not evident in FIG. 1).

The cap contains a through-passage opening or through-opening 2, which comprises a conical depression. The conical depression is realized by an in particular externally cylindrical tube 4 with a conically tapering internal diameter, which is arranged in the cap. The tube 4 provides a female connector element. The opening 2 or the female connector element can be closed at the upper end by a closure 6. The closure 6 is connected to the cylindrical tube 4 via a flexible connection, and therefore the closure 6 cannot get lost. The cylindrical tube 4 may be configured in one piece with the closure 6. The closure 6 comprises a releasable latching means 8, which engages in a mating latching means on the tube 4, and therefore the closure 6 can be fastened in a releasable manner on the cylindrical tube 4. As a result of the closure 6, it is not possible for any contaminants to pass through the opening 2 if there is no syringe (not shown) connected to the opening 2.

It is possible for the cap to consist essentially, or even fully, of plastics material and to be produced preferably by injection molding. The tube or the female connector element 4 contains a nonreturn valve 52, preferably designed in the form of a duckbill valve 52 (see, in this respect, FIG. 7 and the associated description). The nonreturn valve 50 is arranged such that it is possible for milk to be removed from the container. The nonreturn valve 52 thus prevents liquid from entering into the container in the downward direction, through the opening 2, from above the cap. With the milk container connected and syringe connected, liquid is thus prevented from flowing from the syringe into the milk container. The integrated duckbill valve allows a unidirectional flow through the cap, wherein a forward flow (out of the connected milk container) is possible and contamination by backflow into the milk container is prevented.

The geometry of the opening 2 in the cap can ensure that all of the breast milk can be removed from a connected milk container 40 when the milk container 40 is connected in an upended state to the cap (as shown, for example, in FIG. 6). For example, the underside of the female connector element is aligned with the underside of the cap.

The inner walls of the tube 4 or of the female connector are coated with an antibacterial coating made of silver, for example made of silver nanoparticles. In addition, or as an alternative, the coating may also comprise other, or further, pharmaceutically active substances which serve for killing off germs, fungi and microorganisms. This makes it possible to prevent the breast milk from being contaminated when it is removed with a syringe by way of the opening 2.

It is also the case that a ventilating valve 10, comprising a filter for filtering microorganisms, is arranged on the upper side or in the cap. The ventilating valve 10 allows air from above the cap to pass downward through the cap, the air being filtered through the filter in the process. It is thus possible for air to flow into a connected milk container from the outside in order to allow pressure equalization in the milk container when liquid is removed from the milk container. The filter serves to prevent contamination of the breast milk in the milk container.

The outer sides of the cap are provided all the way round with projecting ribs 12. As a result of these ribs 12, the cap can readily be subjected to screwing action for fastening purposes, and for release from a milk container; a user's fingers, therefore, do not readily slip off.

The cap shown is a top according to the invention which can be screwed on a milk container. The milk-container top has a female connector element, and a male connector element of a syringe can be inserted in the opening thereof, in order for breast milk to be removed. The female connector element is provided essentially by the tube 4. The internal diameter and/or the configuration of the tube 4 are/is adapted to the outer shape of the male connector element of the syringe. The male connector element of the syringe, when inserted into the opening 2, butts in a sealed manner against the inner walls of the tube 4 and thus closes off the through-opening 2 in a sealed manner. The antimicrobial coating, which is arranged at least on the inner walls of the tube 4, prevents the breast milk from being contaminated. Such connections are particularly suitable for medical purposes and allow the syringes to be changed over quickly. In one configuration, the female connector element and/or the male connector element are/is designed in the form of a female and/or male EN lock connector element or PG lock connector element. The aforementioned PG lock or EN lock connecting system has the particular advantage that it cannot get mixed up, or is not compatible, with a connection for intravenous syringes and systems, in particular based on Luer or Luer lock systems, and the risk of incorrect use is therefore reduced. For example, an EN lock connecting system has a screw connection for connecting the male connector element in a releasable manner to the female connector element. For reasons of simplified illustration, the figures, rather than showing the connecting system as a PG lock or EN lock connecting system, illustrate the connecting system as a straightforward screw connection with a thread turn.

FIG. 2 shows a perspective view, partly in section, of a cap according to the invention with a male connector element 20 inserted, the male connector element 20 in this case being in the form of an inserted tip 20 of a syringe 22. The cap comprises a tube 4, which provides a through-opening 2. The inner side in the tube 4 comprises an internal thread, and therefore the male connector element 20 of the syringe 22, on which an external thread is arranged, can be screwed in. This may give rise to a stable connection between the cap and the syringe 22. The inner side of the tube 4 is coated with an antimicrobial coating.

The cap comprises a ventilating valve 10 for ventilating a milk bottle (not shown) which is, or can be, connected to the cap. The female connector element and the male connector element are preferably designed in the form of a female and/or male PG lock or EN lock connector element. A PG lock connecting system is known to a person skilled in the art and has been submitted as a draft to the ISO working group ISO/CD 80369-3 “Enteral and gastric applications” and is available for inspection there. An EN lock connecting system is known to a person skilled in the art and is described, inter alia, in WO 2010/115598 A1. Furthermore, the EN lock connecting system has been submitted as a draft to the ISO working group—TC210/JWG4, PG3—enteral connectors—and is available for inspection.

Under certain conditions, it may be expedient for the syringe not to be connected directly to the opening 2. FIG. 3 shows, in this respect, a schematic perspective view of a cap according to the invention with an extension 26. The extension 26 comprises an adapter 28, which is in the form of a male connector element of a syringe. The adapter 28 can therefore be connected to the opening 2 of the cap when it is plugged into the cylindrical tube 4 or into the female connector element.

The other end of the extension 26 has arranged on it a mount 30, of which the interior is designed like the interior of the female connector element of the cap. This means that the syringe with the male connector element can be inserted into the mount 30 of the extension 26 and breast milk can be removed, by way of the extension 26, from a milk container connected to the cap. The extension 26 may comprise a plastics-material hose or a plastics-material tube. Materials other than plastics are also possible, and usable, in principle.

The mount 30 has fastened on it a closure 32, which can be used to close off the extension 26. For this purpose, the closure 32 is connected to the mount 30 via a flexible clip.

FIG. 4 shows a schematic side view of a cap according to the invention with a tube 4 in the form of a female connector element with an opening (not evident) as a through-passage through the cap. The tube 4 can be covered by a closure 6 connected to the tube 4. The closure 6 consists of a plastics material. It is possible, in principle, for the entire cap to be produced from a transparent plastics material, in order to allow a visual check of the contents of a connected milk container. A further through-passage or opening in the cap is formed by the ventilating valve 10.

It is also the case that ribs 12 are arranged, as engagement means, on the outer circumference of the cap, so that the cap, as milk-container top, can be screwed manually onto a milk container. Preferably the entire inner side of the tube or of the female connector 4 is coated with an antimicrobial layer.

FIG. 5 shows a schematic perspective view of a cap according to the invention with a syringe 22 not yet inserted. The male connector element 20 of the syringe 22 can be inserted in a precisely fitting manner into the opening of the cap. For this purpose, the male connector element 20, which is partially conical on its outer side, is plugged in the tube or female connector 4, of which the interior is of correspondingly partially conical design, and therefore the syringe 22 is connected in a sealed manner to the cap. In order to prevent contamination to the syringe 22 and to the medium transported through the through-opening, the inner walls of the tube or female connector 4 are provided with an antibacterial surface.

The antibacterial layer, for this purpose, comprises silver particles of small diameter. The silver particles have, on average, a diameter of less than 1 μm, in order to form a sufficiently large silver surface. A ventilating valve 10 is arranged alongside the tube 4, it being possible for air to penetrate through said valve into a container connected to the bottom of the cap. If the container does not have any flexible walls, it is thus possible to ensure pressure equalization when the syringe is used to withdraw a liquid medium from the container.

FIG. 6 shows a schematic perspective view of a cap according to the invention and also a wideneck milk bottle 40, to which the cap can be connected. The cap and the milk bottle 40 can be screw-connected to one another here at the wide neck via a thread.

FIG. 7 shows a schematic cross-sectional view of a cap according to the invention. The cap comprises a central opening 2, which is designed in the form of a through-passage in a tube 4. The tube 4 provides the female connector element. The upper end of the tube 4 is designed to taper conically downward and has an internal thread 50 in its interior. The tube 4, in FIG. 7, projects upward beyond the top surface of the cap. In the downward direction, the tube 4 terminates flush with the cap.

It is also the case that a duckbill valve 52 is arranged in the interior of the tube 4. The valve 52 can be opened by the intake action provided by means of a connected syringe (not shown). The one-way function of the valve 52 prevents backflow into the container. In the non-connected state of the syringe, the valve 52 is closed.

Two fastening means 54, 56 are arranged on the underside of the cap. The outer fastening means 54 is an internal thread 54 for fastening a milk container which has a wide neck with an external thread. The inner fastening means 56 is an external thread 56 for fastening a milk container which has a narrow neck with an internal thread. It is also the case that cutters 58 are arranged on the underside of the cap, it being possible for these cutters to cut open a protective film which can be used to close the milk container (not shown).

The cap is thus suitable for different milk containers, for example for those with a wide neck and those with a narrow neck and also for those which are covered by a protective film. Variable multipurpose connections allow use with different milk containers. The cap is preferably a multipurpose connector for enteral application, as is described in the application WO 2008/028 582 A1.

The features of the invention which are disclosed in the above description, and in the claims, figures and exemplary embodiments, may be essential both individually and in any desired combination for realizing the various embodiments of the invention and may be combined with one another if appropriate.

### LIST OF DESIGNATIONS

2 Opening
4 Tube or female connector element
6, 32 Closure
8 Latching means
10 Ventilating valve
12 Rib
20 Tip/male connector element
22 Syringe
24 Thread
26 Extension
28 Adapter
30 Mount
40 Milk bottle
50 Internal thread
52 Duckbill valve
54, 56 Thread/fastening means
58 Cutter

1. A cap for a container for accommodating a liquid for enteral nutrition, in particular for a milk container, comprising a holder for fastening the cap on the container and also comprising a female connector element, which is arranged in the form of a through-opening in the cap and is intended for connecting to a male connector element, wherein at least the female connector element, at least in part, has an antimicrobial surface.

2. The cap according to claim 1, wherein the holder is designed in the form of a wideneck-bottle adapter, a narrowneck-bottle adapter and/or a plug-in connection.

3. The cap according to claim 1, wherein the female connector element, at least in part, is conical, and an at least partially conical male connector element can be accommodated in the female connector element.

4. The cap according to claim 1, wherein the antimicrobial surface is provided by an antimicrobial coating and/or by an antimicrobial material.

5. The cap according to claim 1, wherein the antimicrobial surface comprises silver.

6. The cap according to claim 1, wherein the cap has a fluid-tight ventilating channel, wherein the fluid-tight ventilating channel comprises a ventilating valve and/or a ventilating filter, in particular a bacteria filter.

7. The cap according to claim 1, wherein the ventilating valve and/or the ventilating filter have/has, at least in certain regions, a hydrophobic surface.

8. The cap according to claim 1, wherein the cap, preferably the female connector element, comprises a fastening device for fastening the male connector element.

9. The cap according to claim 1, wherein the fastening device is configured in the form of a rotary locking element, a bayonet closure or a thread, wherein the fastening device can be connected in a releaseable manner to the male connector element.

10. The cap according to claim 1, wherein the thread is designed in the form of an internal thread in the female connector element, for fastening a male connector element with an external thread.

11. The cap according to claim 1, wherein the female connector element extends, preferably centrally, through the cap and/or extends beyond a top surface of the cap and can be covered preferably by a closure.

12. The cap according to claim 1, wherein the female connector element is assigned a nonreturn valve, preferably designed in the form of a duckbill valve.

13. A liquid container for enteral nutrition, comprising a cap according to claim 1, wherein the cap is connected in a releasable manner to the liquid container or is fixed to the liquid container, preferably is configured in one piece with the liquid container.

14. A set comprising a liquid container, according to claim 13.

15. The set according to claim 14, wherein a syringe having a male connector element and/or by an extension which is in the form of a tube or of a hose and has a first end, which can be connected to the female connector element of the cap, and a second end, which has a further female connector element for connecting to a male connector element.

16. A set comprising a liquid container for enteral nutrition and a cap according to claim 1, wherein the cap is connected in releasable manner to the liquid container or is fixed to the liquid container, preferably is configured in one piece with the liquid container.
